(19) United States
(12) Patent Application Publication
(10) Pub. No.: US 2011/0185291 A1
(43) Pub. Date: Jul. 28, 2011

(54) SYSTEM AND METHODS FOR AN ONLINE DEBATE

(76) Inventor: Joshua Robert Miller, (US)

(21) Appl. No.: 12/885,068

(22) Filed: Sep. 17, 2010

Related U.S. Application Data
(60) Provisional application No. 61/297,796, filed on Jan. 24, 2010.

(51) Int. Cl. G06F 15/16; G06F 3/048

(52) U.S. Cl. 715/753

(57) ABSTRACT

A system for online debating hosted on a server that allows a first and at least a second participant to engage in an online debate created by an administrator. The system for online debate may comprise an administrator interface, and system module, and a participant interface. The administrator interface may be configured to initiate the online debate, modify a pairing of the participants, and receive administrator feedback. The system module automatically executes software after initiation of the online debate and may be configured to pair the first participant and at least the second participant from a database. The participant interface may be configured to display a topic and a description, receive and display an argument from the first participant and a counterargument from the second participant, limit arguments and counterarguments to a predetermined number of cycles, receive participant feedback, display administrator feedback and participant feedback; and receive and tally votes as to a winner of the debate.

### CROSS REFERENCE TO RELATED APPLICATIONS

This application claims priority to U.S. Provisional Application No. 61/297,796 filed on Jan. 24, 2010 entitled “Debate Interaction System” which is herein incorporated by reference.

### BACKGROUND OF THE INVENTION

1. Field of the Invention

This invention is generally in the field of software that facilitates communication in the form of a debate.

2. Description of Related Art

So as to reduce the complexity and length of the Detailed Specification, and to fully establish the state of the art in certain areas of technology, Applicant herein expressly incorporates by reference all of the following materials identified in each numbered paragraph below.

U.S. Pat. No. 7,369,808 (2008) provides an internet-based learning system where content is stored online, and delivered via different methods depending on a learning style choice chosen by the student, including collaboration with another student.

U.S. Pat. No. 5,310,349 (1994) provides for an electronic or virtual school with electronic content grouped into “classes”. Users interact with other users, as well as course content.

U.S. Pat. No. 5,395,243 (1994) proposes an electronic, interactive learning system.

U.S. Patent Publication Number 20060168233 (2006) describes a system for eliminating geographic barriers that historically hindered educators from distributing content to students information exchange between educators and students with generalized assignment tracking and online discussion boards.

U.S. Pat. No. 6,944,655 (2005) describes a communication system where two users can define the visual instance and appearance of their communication.

U.S. Pat. No. 6,347,332 (2002) describes a system where users can create and participate in a debate while the system or users assist in confirming the quality of arguments to make a truth-based judgment.

Applicant believes that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), applicant(s) will amend the specification to expressly recite the essential material that is incorporated by reference as allowed by the applicable rules.

### BRIEF SUMMARY OF THE INVENTION

For many years, educators and trainers have had few options available to them in how to create writing assignments for students and trainees. The traditional assignment is an essay, or paper. These assignments vary in length and topic, but are primarily done on a solitary basis. A single student or trainee will write the essay, or do research as needed, and/or write the paper as required. Sometimes supplemental materials are added, but it is still a mostly solitary experience.

There are instances though when an educator or trainer might decide to have students or trainees group and collaborate on a writing assignment. The primary change is typically a larger focus on research, as well as an extension of length since group members will probably separate the assignment into individual pieces. However, the end product is not much different than what educators or trainers would receive in the solitary version of the scenario.

For students or trainees to learn though from feedback, a burden is placed on the educator or trainer to grade and provide such feedback. In the case of language arts classes, where students are learning to read and write in several different styles (even poetry) the burden is quite large on the educator. Larger research papers also place a large burden on the educator or trainer to read and provide meaningful feedback to each student or trainee.

For most educational institutions, as well as most businesses, and other kinds of organizations that may have internal or external training, the descriptions above encompass the majority of types of writing assignments available for educators or trainers to assign. For more advanced trainees and students, a wider variety of writing styles and documentation can be taught to the students or trainees, leading to new kinds of assignments, but these still take the same general format. The more advanced forms of training and education still include a sample piece of writing written by the student or trainee, delivered to the educator or trainer.

Other forms of communication are clearly taught and graded on within organizations too. Different classes or training sessions may require students or trainees to give speeches on different topics or group presentations. Other classes or sessions may lead discussions during the class or session, led by the educator or trainer, with the educator or trainer keeping track of discussion contributions by students or trainees that they may use later for grading/feedback. Internet-based schools and courses sometimes emulate these other types of learning in their own internet tools. Forums may be created, with requirements from the educator for students to discuss topics in forums or private groups. This can create dialogue between students similar to what would occur in a live in-class discussion. But speeches and presentations are rarely given through internet-based courses, and interaction usually leads to the forum discussions and traditional paper or essay assignments.

One last style of teaching or training employed by some educators or trainers is in-class debates. Educators or trainers may pick a topic and pair up their students or trainees, or create opposing teams of students or trainees. This is essentially a more structured form of the in-class discussion, and can create some lively dialogue. The educator or trainer can focus the entire group's attention on one pair of debaters at a time, or the educator/trainer may have students or trainees debate simultaneously, without the attention of their classmates.

For traditional educators or trainers outside of internet-based courses, other forms of teaching and training can be used with great variety within the classroom. Within internet-based courses, debate-specific functionality has been limited, only briefly referred to in a couple of the prior art references below. But when asking students or trainees to apply what they have learned by doing assignments on their own time, from their own homes or workspaces (or any other places students or trainees may go to do their work) the educators or trainers are still limited to the traditional essays, papers, and other assignments that students or trainees are able to do on their own time (or with teammates if doing a group paper).

The present invention provides among other things a method and system of administering an online debate. These objects may also be met by a piece of software.

The above and other objects may be achieved using devices such as an administrator interface, system module, participant interface, and nonparticipant interface. The administrator interface is configured to initiate the online debate when the administrator enters such a command, and can required information such as due date, etc., for the online debate; after the online debate has been started, the administrator interface can be used to modify the participants' or teams' pairing and receive administrator feedback. It can also display statistics relating to participant performance or receive and display an argument from the administrator if one participant fails to participate. The system module automatically executes software after initiation of the online debate and can pair the participants from an electronic database. It also stores participant arguments to a computer-readable medium and can electronically send an access code to the participants. The participant interface displays a topic and a description of the debate when the participants log in and receives and displays arguments and counterarguments from the participants. The interface will limit arguments and counterarguments to a predetermined number of cycles, as well as limiting one argument or counterargument in response to a previous one. Participants can also enter feedback about the debate or their opponent through the participant interface, which will display administrator feedback and participant feedback. The interface may also receive and tally votes as to a winner of the debate, which participants can vote for. A nonparticipant interface might also be utilized to allow nonparticipants to follow the debate and enter a vote for the debate winner.

The above and other objects may be achieved using methods to administer the debate. First, the computer would initiate the online debate and pair the participants from a database, and the administrator would enter any required information. As an alternative to individual pairs, the administrator may elect to group particpants into teams, which are then paired. The computer may send an access code by electronic media to the participants; after the participants log in, the computer can display a topic and a description. The participants' arguments and counterarguments would be limited to a single response to a previous argument or counterargument for a predetermined number of cycles, and they would be displayed by the computer. The computer stores the arguments and counterarguments to a computer-readable medium, and displays statistics about participant performance. In the event that a participant fails to participate, the computer can receive and display an argument from the administrator. The administrator can also modify the pairing of participants. The computer can display administrator feedback and participant feedback and accept and display input from a nonparticipant as the winner of the online debate. The computer finally may tally the total votes as the winner of the online debate.

The above and other objects may be achieved using any appropriate software platform that executes a number of computer-readable program codes. Another embodiment of the present invention may be presented as a piece of computer software or control logic stored on a computer readable medium. The computer-readable program code can initiate the online debate after an administrator command including the entry of required information, pair the participants from a database, or modify the pairing of participants. The computer-readable program code can send the access code to the participants electronically and display a topic and description when they log in. The computer-readable program code may receive and display arguments and counterarguments, limited to a single response to a previous argument for a predetermined number of cycles.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventor is fully aware that he can be his own lexicographer if desired. The inventor expressly elects, as his own lexicographer, to use only the plain and ordinary meaning of terms in the specification and claims unless they clearly state otherwise and then further, expressly set forth the “special” definition of that term and explain how it differs from the plain and ordinary meaning Absent such clear statements of intent to apply a “special” definition, it is the inventors' intent and desire that the simple, plain and ordinary meaning to the terms be applied to the interpretation of the specification and claims.

The inventor is also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventor is fully informed of the standards and application of the special provisions of 35 U.S.C. §112, ¶ 6. Thus, the use of the words “function,” “means” or “step” in the Detailed Description or Description of the Drawings or claims is not intended to somehow indicate a desire to invoke the special provisions of 35 U.S.C. §112, ¶ 6, to define the invention. To the contrary, if the provisions of 35 U.S.C. §112, ¶ 6 are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. §112, ¶ 6. Moreover, even if the provisions of 35 U.S.C. §112, ¶ 6 are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1 depicts an embodiment of a system for online debating.

FIG. 2 depicts an embodiment of a method for online debating.

Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

In one application of the invention software allows an administrator account to initiate an online debate for at least two participants. In other applications of the invention, the administrator may initiate an online debate for three, four, five, or any number of participants individually or in teams. The administrator account must initiate the online debate and enter required information such as the title of the debate, descriptions of the two opposing viewpoints, the number of cycles the argument may progress to, and the due date. The participants or teams are paired from a database of students, employees, etc., or using generated codes distributed to participants for purposes of pairing. In the event that a participant or team fails or is not able to participate, the administrator account can modify the pairing or even submit an argument in place of a participant. The administrator can assign a first participant to make an argument or the first participant to log on can be allowed to make the first argument. In either case, once the first argument has been made, responses can only be directed towards the previous argument for a limited number of cycles. This will prevent a participant from making two arguments and bifurcating the debate. The administrator and participants can leave feedback about the participant performance, and any authorized groups including administrators, participants, and nonparticipants can vote as to who the winner is; the software would tally the vote and determine the winner of the date. Statistics will be valuable to evaluate participant performance. Statistics potentially could include the winner of the date, number of votes, length of time to respond to opponent's argument, etc.

Because the participants generate a fair amount of text, the software would automatically save the arguments to some form of computer readable medium. The software for the online debate may be hosted as a website on a server accessible over the internet, but the website could just as easily be hosted on a private network and accessible with any web-capable device like a cell phone, laptop computer, or a desktop computer. Because the participants may be online, the debate code could be sent via electronic media to expedite the online debate; this would be faster than oral communication or paper communication, but those do remain valid methods of communicating the debate code.

The software may pair up the participants or teams from the list in various ways, but the administrator may modify the pairing to account for an odd number of participants or in the event that a participant ceases to participate. Participants that then log in on their own time will then have to complete the debate according to the administrator's parameters for the assignment. Participants will enter the login code into the application, and then either log in to an actual account if the participant already has one, or will then need to create an account if they do not. Either way, the participant's account, and all of its information, is then tied to that debate code, and through that, to the appropriate debate itself. The tool can work without requiring participants to have accounts at all, but the preferred method is to have participants use accounts, because of the possibility of them participating in multiple debates. The tool can also work differently for the e-learning situation where participants are already online, separate from this tool. If they have an account within the tool, participants will have increased ease of use by having their relevant debates all in one place when they log in, rather than having to continually use separate login codes.

Participants or teams will take turns writing and submitting arguments, that are subsequently countered by their opponent, who is another participant. The administrator or institution can provide customized guidelines that are displayed for participant use as they write in the tool. Several debate structures are available, at the administrator's discretion when the administrator creates the debate. The debate will continue until the participants have submitted all arguments according to the administrator's choice of debate length and structure.

At the administrator's discretion, the system can also provide participants that have completed the debate with completed debates of other participants in this particular assignment, so the participant can read, critique, and vote for a winner of the debate the participant has read. The software system provides the administrator with access to read all participants' debate interactions, as well as a suite of statistics that can be used to make the administrator's grading and assignment management process easier, both while debates are in progress, and when all are completed. This also allows the administrator to respond if one participant in a pair is not entering arguments, keeping their opponent from completing the assignment. If such a situation occurs, the administrator can see it on the debate statistics page, and can notify the participant user that is not doing their part, and can even re-assign pairs if two separate participants are not executing. Then the administrator can belatedly pair up the participants who were participating, allowing them to continue the debate.

In another application of the invention, a computer readable medium for conducting an online debate is disclosed. The online debate may be initiated by an administrator conducted by control logic in the computer readable medium and may include a first and at least a second participant. In other embodiments, three or more participants may be included. The control logic may comprise eight computer-readable program codes. The computer-readable program codes may be programmed in any way to fulfill the descriptions, as will be apparent to one skilled in the art of programming.

The first computer-readable program code comprises any code for initiating the online debate after an administrator command. The second computer-readable program code comprises any code for pairing the first participant and at least the second participant from a database. The third computer-readable program code comprises any code for modifying the pairing of the first participant and the second participant from a database. The fourth computer-readable program code comprises any code for displaying a topic and description. The fifth computer-readable program code comprises any code that receives and displays an argument from the first participant and a counterargument from the at least second participant. The sixth computer-readable program code comprises any code for limiting participant arguments to a predetermined number. The seventh computer-readable program code comprises any code for receiving and displaying administrator feedback and participant feedback from the administrator and participants. The eighth computer-readable program code comprises any code for tallying votes as to the winner of the debate.

In other embodiments of the present invention, a ninth computer-readable medium may be present in the control logic. The ninth computer program code may comprise any code for storing participant arguments to a computer-readable medium; receiving and displaying a single argument or counterargument in response to a previous argument or counterargument; displaying statistics relating to participant performance; receiving required information for the online debate after an administrator command; electronically sending an access code to at least one participant; accepting and displaying a nonparticipant vote to select a winner of the debate; or displaying an argument from the administrator if the first participant or the at least second participant fails to participate.

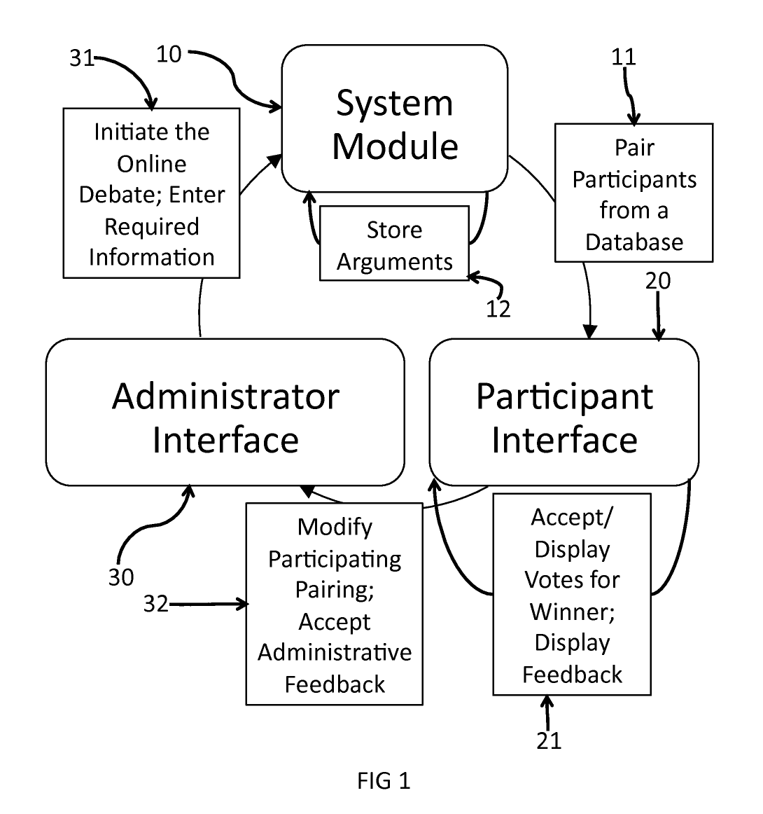

Turning now to FIG. 1 which depicts a system of online debating according to various aspects of the present invention, the embodiment shown in FIG. 1 is comprised of a system module 10, administrator interface 30, and participant interface 20. The administrator interface 30 may comprise any system for initiating a debate and entering required information, such as commands from an administrator, random information generation, automatic information entry, and the like. In the present embodiment, the administrator interface 30 accommodates commands from an administrator to initiate a debate and enter required information 31. In other embodiments, the administrator interface 30 may comprise a medium for the administrator to receive feedback.

In other embodiments of the present invention, the administrator interface 30 may be further configured to display statistics relating to performance, such as grading of arguments, argument not entered in time, time or cycles remaining, and the like.

In yet another embodiment of the present invention, the administrator interface 30 may be further configured to receive required information for the online debate. Information received by the administrator interface may come from a variety of sources, such as the administrator, the participants, computer programs, downloaded information from the internet, and the like.

In another embodiment, the administrator interface 30 may be further configured to receive and display an argument from the administrator if the first, second, third, or any participant or team fails to participate. Entry of this argument may be from a variety of devices, such as personal computers and keyboard entries, text messages, emails, instant messages, and the like.

The system module 10 may comprise any system that automatically executes software after initiation of the online debate. The system module 10 may be further configured to pair participants or teams in a debate, such as random or methodical pairing participants from a database 11, selection based on administrator entries, and the like. In the embodiment shown, the system module 10 pairs the first and at least second participant from a database. The pairing can further be modified by the administrator interface 30 as needed or desired 32.

The system module 10 may further comprise any system for saving arguments once the debate has begun, such as saving the arguments to a computer readable medium 12, printing the arguments, emailing the arguments, and the like. In the embodiment pictured in FIG. 1, the system module 10 saves the arguments to a computer readable medium 12.

The participant interface 20 may comprise any system configured to display a topic and a description, such as a central display, a text message, an email, participant computer displays, and the like. The participant interface 20 may further be configured to receive and display an argument from the first participant or team. Once the argument of the first participant has been displayed, the second participant or team may enter a counter argument the participant interface 20 will receive and display. Arguments by the first, second, or any participant or team may be entered by a variety of methods, including but not limited to keyboards, smartphones, emails, text messages, instant messing programs, and the like. The participant interface 20 may further comprise any configuration to receive and display a single argument or counterargument in response to a previous argument or counterargument. The participant interface 20 may also comprise any configuration for limiting the length of the debate, such as a time period or a predetermined number of argument/counterargument cycles.

The participant interface 20 may comprise any system for providing feedback to participants, such as displaying feedback 21, printing feedback, emailing feedback, and the like. In the present embodiment, the participant interface 20 displays feedback 21 from either the administrator or the participant in order to guide the online debate. The participant interface 20 may be further configured to receive participant feedback. The participant interface 20 may be further configured to find or display a winner of the debate, such as the administrator choosing the winner or accepting and displaying votes.

In another embodiment, the participant interface 30 may be further configured to receive and display an argument from the administrator if the first, second, third, or any participant fails to participate. Entry of this argument may be from a variety of devices, such as personal computers and keyboard entries, text messages, emails, instant messages, and the like.

In another embodiment of the invention, the system may further comprise a nonparticipant interface. The nonparticipant interface may be configured in any manner to receive and display a nonparticipant vote to select a winner of the debate. The nonparticipant interface may be configure to receive the nonparticipant vote in a variety of communications, such as text messages, instant messages, emails, keyboard entry, and the like. Display of the vote and debate winner may also comprise a variety of displays, such as on personal computer screens, a central screen, text messages, instant messages, emails, and the like.

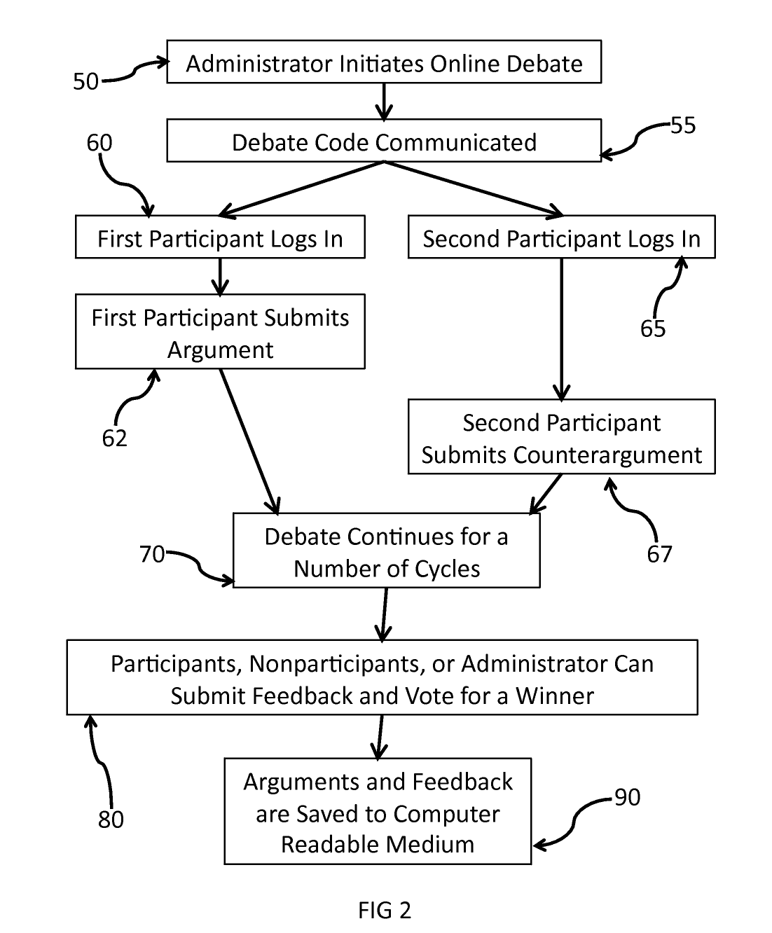

Turning now to FIG. 2, a method of administering an online debate according to various aspects of the present invention is shown. The online debate may be initiated by anyone, including the administrator, the student participant, outside participants, and the like. In the present embodiment, an administrator such as a teacher or supervisor initiates the online debate 50.

Once the online debate has been initiated, the participants in the debate may be paired together by a variety of methods, such as a computer randomly picking participants, a computer methodically picking participants, the administrator picking participants, students voting on participants, and the like, or may be in team pairings instead of individual pairings. In the present embodiment, pairing is done randomly by the computer to select a first and a second participant or team. In other embodiments, the computer may select any number of participants as entered by the administrator. The administrator may further modify the pairing of the first and second participants or teams. Participants may then be notified of the debate access code 55 by a variety of methods, such as software sending an alert to emails, instant messages, texts, or by administrators telling participants of the code. Once participants have the access code 55, the first participant may log in 60 and the second participant may log in 65. In other embodiments, a third, fourth, fifth, or any number of participants may be sent the access code and may log in.

The method may further comprise the displaying by the computer of a topic. In other embodiments the computer may also display a description of the topic. After the topic is displayed, the first participant the first participant enters an argument 62. In other embodiments, the administrator may enter required information for the online debate. In yet another embodiment, the first participant will have a timer, clock, or the like showing on a display how much time the first participant has to enter an argument. Once the first participant has entered an argument, the second participant can offer a counterargument 67. In various embodiments, the second participant will also have a time, clock, or the like showing on a display how much time the first participant has to enter an argument. Other embodiments will allow the administrator, nonparticipants, and the like to also view the timing device. The debate continues as such for a predetermined number of cycles 70. In various embodiments of the present invention, the arguments or counterarguments in response to a previous argument or counterargument may be displayed. If, at any time during the debate, a participant fails to participate, various embodiments allow the administrator to send an argument that is received and displayed by the computer.

During this process, participants and the administrator can enter feedback, which is visible to the others as well as voting for a winner of the debate 80. A winner of the online debate may be decided in a variety of ways, such as tallying by the computer votes received, administrator decision, and the like. Votes may come from a variety of participant, nonparticipant, or administrative sources, such as personal computers, smartphones, instant messages, text messages, emails, and the like. Arguments and feedback may then be saved to a computer readable medium 90, printed out, emailed, or the like. In other embodiments, the computer may, at any time during or after the debate, display statistics about the participants' performances. This display may be visible to only the administrator, or to the administrator, participants, and even the nonparticipants, as decided upon by the administrator.

I claim:

1. A system of online debating hosted on a server that allows a first participant and at least a second participant to engage in an online debate created by an administrator, comprising:
an administrator interface configured to:
initiate the online debate;
modify a pairing of the at least two participants; and
receive administrator feedback;
a system module that automatically executes software after initiation of the online debate, configured to:
pair the first participant and at least the second participant from a database; and
a participant interface, configured to:
display a topic and a description;
receive and display an argument from the first participant and a counterargument from the second participant;
limit arguments and counterarguments to a predetermined number of cycles;
receive participant feedback;
display administrator feedback and participant feedback; and
receive and tally votes as to a winner of the debate.

2. The system according to claim 1, wherein the system module is further configured to store participant arguments to a computer-readable medium.

3. The system according to claim 1, wherein the participant interface is further configured to receive and display a single argument or counterargument in response to a previous argument or counterargument.

4. The system according to claim 1, wherein the administrator interface is further configured to display statistics relating to participant performance.

5. The system according to claim 1, wherein the administrator interface is further configured to receive required information for the online debate.

6. The system according to claim 1, wherein the system module is further configured to electronically send an access code to at least one participant.

7. The system according to claim 1, further comprising a nonparticipant interface configured to receive and display a nonparticipant vote to select a winner of the debate.

8. The system according to claim 1, wherein the administrator interface is further configured to receive and display an argument from the administrator if the first participant or the at least second participant fails to participate.

9. A method of administering an online debate by an administrator between a first participant and at least a second participant, comprising:
initiating by a computer the online debate;
pairing by the computer the first participant and at least the second participant from a database;
modifying by the administrator of the pairing of the first participant and the at least second participant;
displaying by the computer a topic and a description;
receiving and displaying by the computer an argument from the first participant and counterargument from the at least second participant;
receiving by the computer arguments and counterarguments for a predetermined number of cycles;
displaying by the computer administrator feedback and participant feedback; and
tallying by the computer votes as to a winner of the online debate.

10. The method according to claim 9, further comprising storing by the computer the arguments and counterarguments to a computer-readable medium.

11. The method according to claim 9, further comprising receiving and displaying by the computer a single argument or counterargument in response to a previous argument or counterargument.

12. The method according to claim 9, further comprising displaying by the computer statistics about participant performance.

13. The method according to claim 9, further comprising entering by the administrator required information for the online debate.

14. The method according to claim 9, further comprising sending by the computer an access code by electronic media to at least one participant.

15. The method according to claim 9, further comprising accepting and displaying by the computer a nonparticipant vote of the winner of the debate.

16. The method according to claim 9, further comprising receiving and displaying by the computer an argument from the administrator if the first participant or the at least second participant fails to participate.

17. A computer readable medium having control logic stored therein that conducts an online debate between a first participant and at least a second participant upon initiation by an administrator, the control logic comprising:
a first computer-readable program code that initiates the online debate after an administrator command;
a second computer-readable program code that pairs the first participant and at least the second participant from a database,
a third computer-readable program code that modifies the pairing of the first participant and at least the second participant after an administrator command;
a fourth computer-readable program code that displays a topic and description;
a fifth computer-readable program code that receives and displays an argument from the first participant and a counterargument from the at least second participant;
a sixth computer-readable program code that limits participant arguments to a predetermined number;
a seventh computer-readable program code that receives and displays administrator feedback and participant feedback from the administrator and participants; and
an eighth computer-readable program code that tallies votes as to the winner of the debate.

18. The computer software product according to claim 17, the control logic further comprising a ninth computer-readable program code that stores participant arguments to a computer-readable medium.

19. The computer software product according to claim 17, the control logic further comprising a ninth computer-readable program code that receives and displays a single argument or counterargument in response to a previous argument or counterargument.

20. The computer software product according to claim 17, the control logic further comprising a ninth computer-readable program code that displays statistics relating to participant performance.

21. The computer software product according to claim 17, the control logic further comprising a ninth computer-readable program code that receives required information for the online debate after an administrator command.

22. The computer software product according to claim 17, the control logic further comprising a ninth computer-readable program code that electronically sends an access code to at least one participant.

23. The computer software product according to claim 17, the control logic further comprising a ninth computer-readable program code that accepts and displays a nonparticipant vote to select a winner of the debate.

24. The computer software product according to claim 17, the control logic further comprising a ninth computer-readable program code that displays an argument from the administrator if the first participant or the at least second participant fails to participate.
